(19) United States
(12) Patent Application Publication
(10) Pub. No.: US 2023/0360417 A1
(43) Pub. Date: Nov. 9, 2023

(54) System for Identification of Tires and Ongoing Communication Concerning Safety Issues Therewith

(71) Applicant: IESPY CORPORATION, Wilmington, DE (US)

(72) Inventors: S Ohannesian, Wilmington, DE (US); Troy Cottles, Wilmington, DE (US)

(21) Appl. No.: 17/612,091

(22) PCT Filed: Nov. 16, 2021
(86) PCT No.: PCT/US21/59578

§ 371 Date: May 27, 2022

Related U.S. Application Data
(60) Provisional application No. 63/114,717, filed on Nov. 17, 2020.

(51) Int. Cl. G06V 30/14; B60C 13/00

(52) U.S. Cl. CPC G06V 30/1448; B60C 13/001

(57) ABSTRACT

A system for tire identification is provided which continuously compares tires mounted on vehicles with tires known to have safety issues. Where a match is discerned for a vehicle mounted tire and a tire having safety issues, warnings are issued to one or all of the vehicle owner, the vehicle dealer, or the vehicle service center.

### BACKGROUND OF THE INVENTION

### 1. FIELD OF THE INVENTION

This application claims priority to U.S. Provisional Patent Application Ser. No. 63/114,717 filed on Nov. 17, 2020, which is incorporated herein in its entirety by this reference thereto.

The invention herein disclosed relates generally to vehicle tires. More particularly, it relates to a computer and software enabled system whereby tires are individually identified, and on an ongoing basis, associated with any defect or safety issues which are related to each individual identified tire, whereupon notifications are sent to dealers, retailers, vehicle servicers, and/or vehicle owners, should any such safety issue be identified.

### 2. PRIOR ART

### Background of the Invention

The proliferation of motor powered vehicles over many decades has caused, and been helped by, the evolution of the modern vehicle tire. Modern vehicle tires are installed on vehicle rims or wheels, which are engaged to the specific vehicle to allow for the rolling thereof upon vehicle roadways. Most vehicle tires, such as those for automobiles and bicycles, are pneumatically inflated and thereby provide a flexible cushion which helps absorb shock as the tire rolls over roadway surfaces.

In modern times, pneumatic tires are formed from synthetic rubber, natural rubber, and include fabric and metal reinforcement. Conventionally, such tires are formed of a body and an engaged tread. The tread provides traction, while the engaged body provides for containment of compressed air which inflates the tire. Such pneumatic tires are conventionally employed on many types of vehicles, including cars, bicycles, motorcycles, buses, trucks, heavy equipment, and aircraft.

However, because they are the only part of the vehicle which contacts the road, the ongoing performance of tires is vital to the safe movement of vehicles upon roadways. Vehicle tires can suffer from manufacturing and design defects as well as defects due to age. While manufacturing and design defects tend to be reported, once identified, undiagnosed tire defects may go unreported for years, and hidden dangers not visible to the human eye, such as separations inside the tire wall, may occur as a result of these defects with continued use and due to the age of the tire. As a tire ages, small cracks in the rubber forming it can develop over time and can cause separation issues between the tread, steel belts, and body. It is important, therefor, that motorists, vehicle dealers, tire retailers, and vehicle servicers be on guard for tire issues which can evolve into serious safety issues.

With respect to the above, before explaining at least one preferred embodiment of the method herein for identifying tire safety issues and communicating notices concerning such, it is to be understood that the system invention herein is not limited in its application to the details of employment and to the arrangement of steps set forth in the following description or illustrated in the drawings. The various apparatus and methods and steps of the herein disclosed system are capable of other embodiments, and of being practiced and carried out in various ways, all of which will be obvious to those skilled in the art once the information herein is reviewed.

Also, it is to be understood that the phraseology and terminology employed herein are for the purpose of description and should not be regarded as limiting. As such, those skilled in the art will appreciate that the conception upon which this disclosure is based may readily be utilized as a basis for other tire identification, monitoring and warning systems. It is important, therefore, that the embodiments, objects and claims herein, be regarded as including such equivalent construction and methodology insofar as they do not depart from the spirit and scope of the present invention.

### SUMMARY OF THE INVENTION

The disclosed system herein, provides a software enabled system and method for obtaining tire facts and tire data concerning tires sold and equipped on passenger vehicles. The software operates upon a computer, such as one or more processors having electronic memory communicably coupled thereto, in which the software such as a non-transitory computer readable medium having computer executable instructions stored thereon configured to the task of providing real-time communications concerning tire safety. The system will communicate with automobile dealers, vehicle service departments, automobile retailers, auto service retailers, tire service retailers, owners of vehicle fleets, tire manufacturers, automobile manufacturers, and individual vehicle owners for the task of providing ongoing information concerning tires identified by the system.

In all modes of the system herein a non-transitory computer readable medium includes the instructions that, when executed by the one or more processors, cause the one or more processors to perform the noted function or operations or task.

Initially, by assembling currently available industry information concerning tires with safety issues and recall information from U.S. and government data, websites and updates concerning known issues with tire safety for specific tires, and searches for information concerning tires in the public record or court records, and gathering tires with a history of tire failures for the purpose of performing forensic analysis, and the scanning of data on tires at dealers and retailers, an electronic and searchable tire safety information database will be formed.

Employing software in a non-transitory computer readable medium having computer executable instructions stored thereon operating to the task of capturing and assigning a tire identifier to each tire in or added to the tire safety information database, each tire will be assigned or be otherwise associated with a tire identifier, for each respective tire which is originally included or later added to the database. The employed tire identifier will relate to each specific tire for which data gathered and will be stored and related within the tire information database.

The tire identifier, so assigned, will preferably be alphanumeric so that it is easily searched using a non-transitory computer readable medium having computer executable instructions stored thereon operating to the task, to discern and identify any stored tire safety information concerning each tire having a tire identifier in the database. For example, the tire identifier may be a Department of Transportation (DOT) tire code or a permutation thereof, since every tire sold in the USA and most industrialized countries must bear such a code. However, the tire identifier may be another alphanumeric identifier that is assembled by a non-transitory computer readable medium having computer executable instructions stored thereon which will employ the DOT tire code, in combination with other tire information gathered, and thereafter assemble the alphanumeric tire identifier.

The tire identifier may, thereafter, be correlated to individual tire identification information for the identified tire, which is stored electronically in the tire safety database. Further, included in the tire identification information or otherwise associated with a tire identifier may be additional tire identification information, such as indicia or symbols and alphanumeric characters which are conventionally placed on the sidewalls of tires in addition to DOT codes. For example, a brand name and tire model may be embossed into the sidewall, along with a DOT code, and may employ a non-transitory computer readable medium having computer executable instructions stored thereon operating to the task of gathering such additional tire identification information and associating it into each tire identifier.

This additional tire information, when associated into or with the tire identifier of tires with safety issues, will subsequently allow users searching for scanned tire identifiers and the stored tire identifiers for a match in the tire safety information database, to input brand names and manufacturer names and other indicia, to ascertain or confirm a scanned tire identifier substantially matches a tire identifier of tires with safety issues and DOT code and should allow for reverse searches of scanned tires.

The system will preferably employ software or non-transitory computer readable medium having computer executable instructions stored thereon for tire information seeking, which will operate to continuously monitor the internet and other online sources of tire information, to seek and assemble and add information concerning the safety of tires in a tire safety database. By continuously monitor is meant that the non-transitory computer readable medium has computer executable instructions stored thereon for tire information seeking at known and newly found electronic and other tire informational locations, such as websites, news sites, phone numbers, and other locations where information concerning safety of tires is known, or becomes known to be available. Operation to seek such new and additional tire information will occur on a default time or input time basis whereupon the non-transitory computer readable medium having computer executable instructions stored thereon to continuously seek tire information will electronically contact or read each such informational location on a schedule, and continuously seek out new information concerning the safety of tires. Additionally, as noted below, experts, employed by the system operator, may also seek out unpublished tire safety information.

By tire safety information is meant determined tire age, recalled tires, tires with a history of tire failures that may be defective, defective tire investigations, expired tires, aged tires, technical service bulletins, tire service department alerts and other tire facts and dangerous tires. Rather than wait for input of tire safety issues, the system will operate, as noted above, to continuously seek out these informational locations to capture tire safety information, such as that issued by a manufacturer or government or industry communications which include warnings or information about tire safety issues. Thus, the non-transitory computer readable medium having computer executable instructions stored thereon will operate to the task of continuously searching for additional tire safety information concerning respective tires, and is continuously updated with new tire identifiers which are added to the tire safety database in substantially the same format.

Using this tire safety database of tires having tire identifiers stored in electronic memory accessible to the system computer or server, which identifies individual tires associated with a tire identifier, which are associated to tire brands and models with any discerned tire safety issues, non-transitory computer readable medium having computer executable instructions stored thereon will operate to ascertain a match with scanned tire identifiers which are identified as a tire mounted on a specific vehicle.

Once a match is made between tire identifiers of tires with safety issues and one or more scanned tire identifiers of tires which are mounted on a vehicle, using non-transitory computer readable medium having computer executable instructions stored thereon, the system will operate to communicate tire safety notifications. Such notifications may be by mail, fax, email, sms text or other means of communication. Such notifications may be sent to the appropriate determined party which may include vehicle owners, auto dealer service departments, tire retailers, vehicle service centers, and other individuals or businesses which deal in tires or vehicles having tires identified as having safety issues.

Upon determination that one or more tires, which have indicia thereon which has been optically scanned, imaged, manually input, or otherwise identified as mounted on a specific vehicle, or in tire seller inventory or the like, which have scanned tire identifiers which are associated with tire identifiers in the database which have tire safety issues, employing non-transitory computer readable medium having computer executable instructions stored thereon configured to operate to the task of communicating warnings, the system will operate to communicate identified tire safety issues to one or more determined parties of interest. Such parties of interest, for example, but in no way limiting, may be an auto dealership service department where the service manager will receive a “service department notification.” Such a notification may instruct the manager to notify their customer and owner of the vehicle which has been identified as having one or more tires which are associated with safety issues, to return the vehicle to the service department, whereupon the tire safety issue may be addressed.

In a response determining step, employing non-transitory computer readable medium having computer executable instructions stored thereon which monitor for responses received from a notified party, the system will continuously monitor communications from notified parties that each respective party acknowledges having received a safety notification and rectified the problem. Absent receipt of a response communication operating in this response determination, the system herein will endeavor to transmit continuous automated notifications to parties associated with the tires deemed to have safety issues. Such ongoing communications may continue to the dealer, tire retailer, vehicle service center, and even to the vehicle owner, if such are associated in the database as having serviced, installed, manufactured or being an owner of the tire having safety issues. In this manner, the safety of the vehicle owner is deemed paramount, and the vehicle owner is encouraged to visit the appropriate party to address the safety issue.

In the system herein, for tires sold by dealers and for tires scanned while on vehicles being serviced, individual tire identification information, from each tire, is preferably captured from an image of a respective tire sidewall, taken of each respective tire. Employing non-transitory computer readable medium having computer executable instructions stored thereon, the captured information concerning each scanned or photographed tire is assigned the scanned tire identifier which is associated in an electronically stored database to the specific vehicle (VIN) on which each tire is mounted. This action is performed for each vehicle a car dealer places in inventory, or which a service center services, or on a vehicle on which a tire dealer installs new tires, or on tires on vehicles visiting any other vehicle venue, where a vehicle is serviced or sold, or for a vehicle which a vehicle owner determines to inform to the tire monitoring service.

This individual tire identification information used in the same fashion for both the tire identifiers of tires with safety issues and the scanned tire identifiers as noted herein, is discerned by an imaging or scanning and reading of a DOT tire code indicia and of other symbols and alphanumeric characters embossed upon the sidewall of each tire. Such DOT tire codes are required by the U.S. Department of Transportation. Further included in the tire identification information may be additional indicia or symbols and alphanumeric characters which are conventionally placed on the sidewalls of tires in addition to DOT codes, such as brand names, manufacturing identifiers and the like.

As described herein, employing a computer having software, which in all modes herein uses a non-transitory computer readable medium having computer executable instructions operating to the task identified for the software. For image discerning and input of either scanned tire indenters or tire identifiers of tires with safety issues, the assembling and storing of the individual tire identification information, for each such tire, is accomplished in the same fashion using an assembled identifier from portions or all of the alphanumeric symbols on a tire sidewall. The tire identifier for tires with safety issues and any scanned tire identifiers are thus assembled from imaging of such DOT codes and of additional indicia or alphanumeric characters positioned on the tire sidewall, which is imaged by the below described imaging step or steps. All this tire identification information, associated with each tire, may be employed to identify specific information about each respective tire, which is included in a DOT code, and which is included in the other images and alphanumeric characters placed on the sidewall during manufacture. A match between a tire identifier of a tire with safety issues and a scanned tire identifier need not be a 100 percent match of each character of each identifier but will be ascertainable by a substantial match of both, because the scanned tire identifier and the tire identifiers of tires with known safety issues will be assembled using the same sequence of alphanumeric characters on a tire.

Such DOT tire codes may be employed for example,
1. A plant or manufacturer code and the date of manufacture of the respective tire bearing the code.
2. The name of the tire manufacturer.
3. Information concerning passenger car tire data which can include one or more of a width of the tire (in millimeters), a ratio of height to width of the tire (aspect ratio), a radial tire marking, s diameter of wheel on which the tire mounts (inches), a tire load index, and a tire speed symbol.
4. Information concerning a maximum cold and inflation load limit.
5. Information concerning treadwear, traction and temperature grades for the respective marked tire.
6. Information relating to the tire ply composition and materials used in the manufacture of the respective marked tire.

Such additional indicia or images and alphanumeric characters, that may be captured during imaging of the sidewall and included in the tire identification information, can include for example, but in no way limiting:
7. A capture and discerning by the system of any other pertinent information depicted in symbols or alphanumeric characters on the respective tire sidewall, such as a brand name under which the tire has been sold, which frequently differs from the manufacturer name, which may be captured and discerned from a sidewall image and correlated to yield additional information about a respective tire.

The imaging and reading of the alphanumeric tire codes and additional alphanumeric characters and images on each tire may be, and is preferably achieved, by automatic means. Such automatic means may be a camera or imaging scanner located at the venue where the tires are shipped or at a venue where a vehicle having such tires visits for service or other reasons.

Such a tire imager or imaging scanner, for example, may capture an image of a sidewall to capture each respective tire code, and the additional images and alphanumeric characters positioned on each tire sidewall, using digital photography. Because the DOT code on tires is embossed into or on the tire sidewall material, in most cases, the color of the embossed DOT code is essentially the same color as the rubber or other material forming the sidewall. The additional alphanumeric characters and symbols such as the brand name and model of the tire, also tend to be the same color as the sidewall of the tire.

Consequently, such a captured and/or assembled digital image of the DOT code and additional indicia or characters and images on the sidewall yielding a scanned tire identifier which is formed in the same fashion as the tire identifiers assigned to tires with safety issues, may be captured and discerned using multiple digital images of each sidewall, having a DOT tire code and the additional alphanumeric characters on the sidewall concerning the manufacturer and other tire elements. The multiple digital images can be taken at differing angles, while flash or other illumination is communicated to the tire sidewall.

From the one or multiple digital images, employing software in the form of non-transitory computer readable medium having computer executable instructions stored thereon operating to the task of reviewing and discerning alphanumeric characters from digital image information from the one or multiple images of a DOT tire code image, and/or from digital images of those other characters and images on the sidewall which are digitally imaged and captured from one or multiple angles, and/or in multiple light frequencies, tire identifiers are yielded.

A final such digital image of the sidewall of the tire may be assembled from such multiple images to yield a software-readable DOT tire code and software-readable additional indicia, such as images and alphanumeric characters positioned on the sidewall to form a scanned tire identifier, which is assembled by such software operating to the task using the individual tire identification information, for each tire.

For example, in one mode of the system herein, a final digital image yielding software-discernable tire identification information, such as the DOT code and other indicia, such as images or alphanumeric characters on the sidewall, may be captured using Multiband Imaging (MBI). Such is commercially available and employs multiple images taken using visible light, ultraviolet-induced visible fluorescence (UVF), ultraviolet reflectance (UVR), IRR, and visible-induced infrared luminescence (VIL) images. Using image combining and subtraction software with the multiple captured images, such as that available from ADOBE, the multiple images taken can be combined to more clearly depict and discern the alphanumeric tire code for each tire.

Similar photo systems for imaging hard to visually discern alphanumeric characters employ the use of visible light, and/or projected light in differing light spectrums, during a capturing of multiple digital images of the DOT tire code, and other sidewall-positioned images and alphanumeric characters. Thereafter, the multiple digital images of the sidewall, taken at different angles relative to the tire code and other indicia positions, are combined by digital image-combining software to an assembled final digital image of each DOT tire code and any other indicia, such as text or images located on the tire sidewall. This captured and assembled final digital image can be converted to database-storable alphanumeric characters and text by optical character recognition software which examines each captured final digital image. The conversion of the alphanumeric characters to a tire identifier or scanned tire identifier will use the same formula to take the scanned alphanumeric characters on each tire and assemble the tire identifier in the same fashion, to thereby enable a substantial match when tire identifiers are compared to known tire identifiers of tires with safety issues. The single or multiple digital images for all modes of the system can be captured by air or land based drones for car lot-positioned vehicles and by stationary digital imaging components for vehicles at a vehicle servicer or dealer locale.

The optical characters, such as text and numbers and/or images discerned by the optical character recognition software within the final digital image, can thereafter be stored in a scanned tire database as individual tires which are related to the inventory of a tire dealer or in the case of a vehicle having the tires thereon, individual tires associated with a specific vehicle (VIN) which are stored in the scanned tire database. Using similar parameters to that used to assemble and assign a tire identifier in the tire safety information database, software operating to the task may assign a scanned tire identifier to each scanned tire. Thus, such information, so stored in the scanned tire database, is related to each respective scanned tire and the respective specific vehicle on which each scanned tire is mounted. The term scanned tire database can also include tire information that is captured by a human and input manually. However, due to the potential for error and the time needed, input from captured images is preferred.

In the case of some vehicle sales and service venues, where the vehicle is driven into a bay or onto a rack or other position, one or a plurality of digital cameras, positioned to capture one or more digital tire sidewall images of each tire, can be positioned to automatically capture images of the vehicle's tires. Thereafter, the final digital image of each tire can be formed in the above noted fashion.

Using these captured and/or assembled final digital images, the DOT codes and the other indicia such as images or alphanumeric characters on the sidewall, will then be converted to electronically storable alpha numeric characters by the software running in electronic memory to the task of optical character recognition in electronic images. By optical character recognition software is meant a non-transitory computer readable medium which operates in computer accessible memory having an executable computer program stored thereon, wherein the program includes computer executable code for recognizing alphanumeric characters from single images or assembled multiple images of embossed characters on a tire image, and computer executable code with determines a tire identifier which is stored to electronic memory in relational databases of tire identifiers.

Thus, this alphanumeric information, so captured and converted from one or a plurality of images of indicia on a tire, is employable by software adapted to the task of assembling and assigning a scanned tire identifier using the same assembly method as the software operating to use information to assign the tire identifiers in the tire safety information database.

In the system, the tire information and a scanned tire identifier, for each scanned tire, may also be associated with the respective vehicle on which the tires are mounted. This is accomplished with the stem of using a digital image of the VIN number and/or license plate of the vehicle, or by a keyboard or other input thereof, or by matching newly recognized tire identifiers on a vehicle with previously stored VIN number placed in the scanned tire database. The owner or operator of the vehicle, having each respective VIN number and/or license plate number, may be identified by the servicing center or dealer, or by a search of DMV records, and also may be associated with the individual vehicle in the scanned tire database for future communications thereto.

In a particularly favored mode of the system herein, the final digital image of each tire on each vehicle on a dealer lot or other venue with many vehicles, may be captured by a flying drone. The drone is equipped with a digital camera configured to take one or the above-noted multiple images directly or from multiple angles and may also use illumination components capable of projecting the noted light spectrum upon the sidewall of the tire. In this mode, a drone, enabled with navigation software operating to move the drone around individual vehicles, may be employed for the imaging of each tire. In this drone mode, it may be released to operate autonomously, and thereby capture images of every tire code and any other indicia or images or alphanumeric characters upon every tire, of every vehicle on a lot or other venue.

The drone operation software will also operate the drone to additionally capture a digital image of the vehicle identification number (VIN number) and/or license plate number from each such vehicle on which the tire sidewalls are imaged. Using the above noted steps and optical character recognition software operating to assemble or otherwise discern the final digital image of the sidewall of each tire, the alphanumeric DOT and other alphanumeric information positioned on the sidewall is converted to the individual tire identification information and, as noted above, a scanned tire identifier for each tire. Software operating to the task of associating the respective individual tire identification information and/or the scanned tire identifier of each scanned tire with the VIN number of the vehicle on which they are mounted, is then employed to save the individual tire identification information and/or scanned tire identifier in association with the VIN number identifying the vehicle, in the scanned tire database.

As noted, subsequent to the capture and/or assembly of a digital image of captured tire codes, optical character recognition software operates to read the final image of a tire code and/or the VIN number image, if also captured. This optical character recognition software will convert the alphanumeric figures from each final digital tire image to the individual tire identification information. Software operating to the task of using this individual tire identification information may assemble or assign a scanned tire identifier for each tire, using the same operation as the software operating to assign tire identifiers in the tire safety information database. This scanned tire identifier and the individual tire identification information is then associated with each VIN number, and such is communicated for storage in electronic memory of the system server to hold both in association in the scanned tire data.

In this fashion, each tire on each vehicle is scanned and the final individual tire identification information for each tire is discerned and associated with the individual vehicle VIN number and/or license plate number. The individual tire identification information, for each tire associated with the identified vehicle, is stored in the scanned tire database by the system operator where it will be available for review and retrieval and comparison in electronic memory on the server or computer of the system. The server or computer may be on site or operated in a cloud environment over a computer network.

For each tire associated with each vehicle within the scanned tire database, the system will employ tire comparing software such as a non-transitory computer readable medium for operating to the task of comparing the respective scanned tire identifier and/or individual captured tire identification information for each tire stored in the scanned tire database, to the tire identifiers in the stored tire safety information database and then determining any matches of respective tires identified with safety issues which are stored in a system tire safety database.

As noted, such tire safety information will relate known safety issues for tires manufactured and sold, which have been identified by government agencies and/or manufacturers, industry or other proprietary information, as having safety issues associated therewith. By safety issues is meant recalled tires, tires with a history of tire failures which may be defective, defective tire investigations, expired tires, technical service bulletins, tire service department alerts and other tire facts and dangerous tires.

An additional safety issue to be considered may be identified by using the captured tire codes to discern the manufacturer of each tire and the date of manufacture of each tire. By comparing the current date to the discerned date of manufacture, the age of each identified tire may be discerned and if the discerned age exceeds that which is safe. For example, tires which are over six years old are conventionally considered to be past the safe lifespan to be employed.

The system will, preferably, also have tire information seeking software running in electronic memory of computers connected to a network such as the Internet. Such tire information seeking software employing non-transitory computer readable medium operating to perform the task of continuously seeking tire safety information concerning tires sold and manufactured, from network engaged databases of government agencies and manufacturers, rather than just waiting for such information to be pushed to them by such sources. This sought tire safety information is continuously added to the tire safety database of defective or safety-impaired tires in association with the individual tire identifiers. The tire information seeking software can also continuously search the Internet for other sources of information concerning defective tires, such as those identified in lawsuits concerning defective tires and newspaper stories about defective tires and government issued warnings concerning newly determined defective tires.

Additionally, to allow for tire recommendations by users, such as dealers and automobile service centers and the like, the tire information seeking software operating to the task of assembling tire information in a relational database can also seek out reviews and ratings and positive news stories concerning individual tires and store such for retrieval. As with the seeking and storing of data concerning defective and dangerous tires as tire safety information, the software operating for positive information on tires would operate to continuously seek out such tire recommendation information, by monitoring automotive magazines, tire magazines, and other publications and websites which review and rate tires.

Upon the capture of tire identification information from tires on a vehicle or otherwise brought to a service center or the like, which is communicated to the scanned tire database, the tire identifier comparison software running on a computer or server will operate using non-transitory computer readable medium operating to the task of matching the scanned tire identifier and/or the individual tire identification information from each respective tire, stored in the scanned tire database, for matches to tire identifiers and/or tire information, in the tire safety database. In doing so, it will operate to compare individual tires in the scanned tire database to that in the tire safety database, to identify any matches to tires in the scanned tire database to those tires in the tire safety database. The tire identifier comparison software, in addition to seeking matches for tire identifiers in the tire safety database to the scanned tire identifiers in the scanned tire database, may also search DOT codes, brand names, and the other information stored in both databases for matches.

Should a match be found concerning a tire safety issue with any individual tire in the scanned tire database to a tire in the tire safety information database, which is associated with any identified vehicle, the system employing communication software employing non-transitory computer readable medium or code operating to the task of communicating warnings, will operate to communicate a safety warning to the retailer, servicers, and/or the owner of the vehicle having the identified VIN number or license plate associated with the tire code identified as having safety issues.

In this fashion, tires positioned on vehicles which are on a dealer lot, or visit a vehicle dealer or other service center, or which visits a tire retailer or any other vehicle service, sale, or repair venue, may be individually scanned and identified and communicated to the scanned tire database whereupon they are checked for safety issues.

Further, should the system, upon determining a match to a vehicle having tires thereon associated with safety concerns, subsequent to sending a tire safety notification to a vehicle owner or customer if known, and to the auto dealer service departments, etc., a service department manager will receive a service department notification concerning the identified tires having safety concerns. This service department notification will instruct the manager to notify their customer or vehicle owner to return to the service department.

Still further, in another step, the communications software, noted above, can operate to send out notices for communication to the actual vehicles identified as having the tires at issue mounted thereon. The message would either be sent directly to the vehicle, using the VIN number and any known electronic communications to that vehicle, or it can be sent to the manufacturer or known dealers or servicers for that vehicle, whereupon it will be communicated to the vehicle. Thereafter, a warning would be communicated to the driver, either visually on a display or by an audible message or both. Notifications sent to the vehicle's dashboard would recommend the vehicle owner return immediately to their auto dealer's service department for safety reasons. As this will effectively increase service department visits and drive additional revenues to the auto manufacturers and their dealers service departments, it will encourage them to notify the vehicle and owner. Additionally, it might avoid potential tire failures that lead to lawsuits and damages against both the manufacturers and dealers.

For example, the auto manufacturers downloading VIN, DOT, OEM tires to their databases and each vehicle's computer system at the time of manufacture, so that tire safety notifications may be sent out to the individual vehicles affected from auto manufacturers' databases. Such may be sent at the time notifications are received by the manufacturers from a third party communicating “tire safety notifications” to manufacturers. Also, possibly, both databases of third parties and auto manufacturers might send an alert to individual vehicles with tire safety issues. Notifications sent to the vehicle's dashboard may be communicated to the driver either visually on a display or by an audible message or both. Additionally, the “tire safety notifications” communication may be referred to as a third-party brand.

Thereafter, ongoing notification software running on the computer or server will operate in an ongoing messaging routine using computer readable medium having an executable computer program stored thereon, wherein the program includes computer executable code for determining if the problems with identified tires for which communications have been sent have been rectified by mounting new tires or the like on the vehicle, and if not, computer executable code will continue to operate either a fixed or default schedule of the notification task, and communicate continuous automated service department notifications on behalf of the service department and manager to the vehicle owner to make an appointment and/or to return to the service department. Such service department notifications will continue until such time that the system determines, or information is input, that the customer has had the identified tire(s) serviced. This determination may occur by manual input of the manager or workers at the service department or by a subsequent scan of the tires upon such a visit in the fashion noted above.

In addition to informing vehicle owners of tire defects the system allows dealers and servicers to promote tire safety and to concurrently provide the car owner or buyer the perception that customer safety is a top priority. The system also provides dealers and servicers an incentive to promote such tire safety with customers, in that it promotes a return to the dealer or servicers which may also provide the opportunity for additional sales.

In an additional step, in the continuous determination of actual or potential tire safety issues, which can be added to the tire safety database used for comparison to the captured tire identification information and/or scanned tire identifiers in the scanned tire database related to specific tires, forensic expert/analysts will, on an ongoing basis, act to identify defective or aged/expired tires. To that task of ongoing tire safety issue determination, the analysts will continuously attempt to locate via Lexis-Nexis databases and online and other investigation specific tires which have not been recalled or identified by government agencies and/or manufacturers, industry or other proprietary information, as having safety related issues, where a specific tire is identified as has having experienced one or have a history of tire failures.

Determined safety issues for each identified tire will be added in an association to a tire identifier of the tire held in the tire safety database, as individual tire identification information of tires discerned as having safety issues. Thereafter, software operates to the tasks of comparing the respective tire identification information to the tire identification information that has been identified with safety issues stored in a system tire safety database.

Additionally, as part of a continuous update to the tire safety database, which stores tire safety information relating to individual tire identification information, the operators of the system herein, may also have a team of forensic analysts, experts, or investigators to locate, open an investigation, examine, and forensically test potentially defective tires that have experienced or have a history of tire failures.

If systemic defects are discovered in any failed tire, communication software operating to send out notifications will send automated real-time expert defective tire alerts or aged/expired tire alerts to auto dealers, auto service retailers, manufacturers, vehicle owners, etc. that will include a (pdf) letter which would include documentation regarding the tire.

Another feature of the system herein, is that a vehicle owner or potential buyer or a car or tire(s) from an auto retailer, tire retailer/dealer, or auto or tire wholesaler, or a potential buyer/seller of a car or tire, or a car with tires from a private party may search online or with the use of an app based device to query the tire database information before or during a negotiation, shopping for and/or viewing or purchasing a tire(s) or a cars' tires.

With respect to the above description, before explaining at least one preferred embodiment of the method of tire identification, monitoring and warning communication system herein, it is to be understood that the invention is not limited in its application to the details of operation nor the arrangement of the components or the steps set forth in the following description or illustrations in the drawings. The various methods of implementation and operation of the system and method herein are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of other methods and systems for carrying out the several purposes of the present tire inspection and warning system. Therefore, that the objects and claims herein should be regarded as including such equivalent construction, steps, and methodology insofar as they do not depart from the spirit and scope of the present invention.

It is an object of this invention to provide an automated system for real time tire identifier capture and identification and a determination of tire safety issues related thereto.

It is a further object of this invention to provide such a tire safety system and method which operates continuously to discern tire safety issues from a plurality of informational sources, to determine subsequent safety issues for tires on a vehicle which may have left the venue, and provide notification to parties associated with any identified tire having a safety issue.

These together with other objects and advantages, which become subsequently apparent reside in the details of the construction and operation of the system herein as more fully hereinafter described and claimed, reference being had to the accompanying drawings forming a part thereof, wherein like numerals refer to like parts throughout.

Further objectives of this invention will be ascertained by those skilled in the art as brought out in the following part of the specification wherein detailed description is for the purpose of fully disclosing the invention without placing limitations thereon.

### BRIEF DESCRIPTION OF DRAWING FIGURE

FIG. 1 shows a flow chart of the method and system herein, showing the steps employed in the disclosed system herein.

FIG. 2 depicts an example of the system herein, employing a flying drone with a digital camera for image capturing of indicia embossed or imprinted on vehicle tires.

FIG. 3 depicts an example of a drone vehicle which is equipped with a digital camera configured to capture indicia embossed or imprinted to vehicle tires.

FIG. 4 shows a sidewall of a typical conventional tire and the indicia concerning the tire, brand, manufacturer, and the like positioned thereon.

### DETAILED DESCRIPTION OF THE PREFERRED EMBODIMENTS OF THE INVENTION

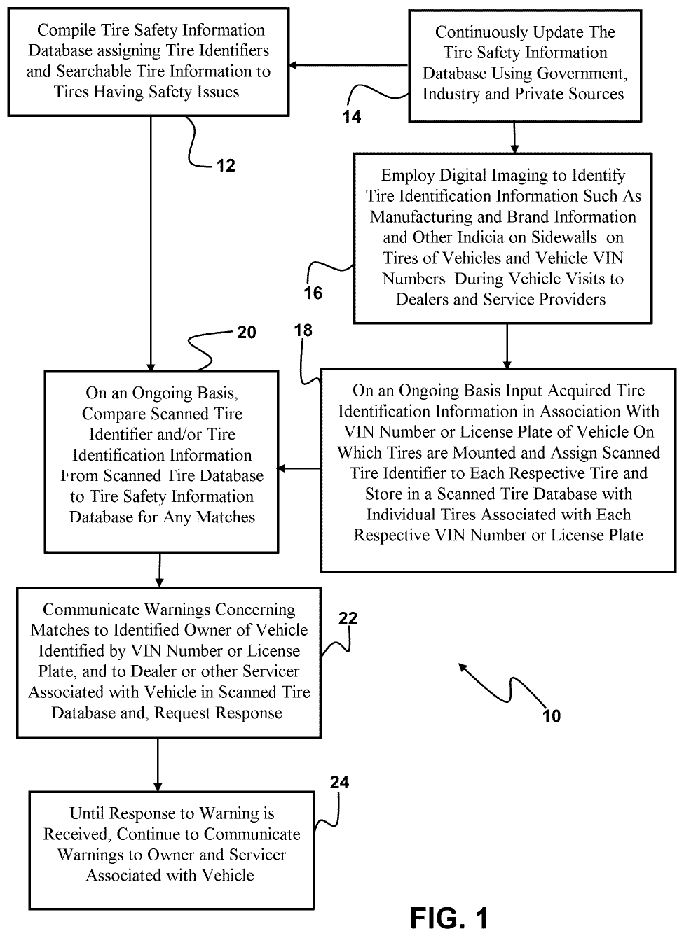

Referring now to the system, the steps therein, and system components, such are shown in simple format in the drawing depictions of FIGS. 1-4 herein. It should be noted that in all modes of the system 10 herein, the system provider will employ a computer or server with accessible electronic memory in operational communication over a computer network, such as the internet, which is accessible for electronic communications with and between the computing devices of tire manufacturers, auto manufacturers, government regulatory agencies, tire and vehicle retailers, vehicle servicers, vehicle owners, and other entities which relate to and report on the sale and use of vehicle tires.

The system provider, in the system herein described, as noted above and further described below, will employ one or a plurality of computing devices, such as computers and servers which have network communications, such as the internet or private networks. The computing devices have accessible electronic memory in which software, configured for the tasks herein, or non-transitory computer readable medium, will operate which employs computer executable instructions stored thereon. Such instructions include the steps herein, such as discerning and/or assembling electronically storable alphanumeric tire identifiers from one or a plurality of digital images and/or manual inputs, and/or available databases thereof, and then storing such discerned tire identifiers in electronic memory in a database relating each tire identifier to the respective vehicles on which the scanned tires are mounted.

A non-transitory computer readable medium having an executable computer program stored thereon, has executable code which will run in electronic memory which operates to perform all the steps and the tasks noted herein. Such electronic memory, in communication with the computing device or server or the like, will also hold, in electronically accessible fashion, one or a plurality of relational databases of tires manufactured, and any safety issues related thereto, as well as any specific vehicle on which a tire with safety issues is discerned as being engaged.

As noted above in detail, the system 10 herein is described in FIG. 1.

In order to enable the system 10 herein, to initially operate and to operate on an ongoing basis, the system operator will compile a tire safety information database 12 having tire identifiers matched to tires known to have safety issues. Such is described in detail above and will continuously provide a searchable relational database held in electronic memory, which will allow users, or software licensed by users, and/or the system operator to automatically query the system concerning scanned tire identifiers, with regard to tires being sold for mounting on vehicles or tires already mounted on vehicles, which are being serviced by the user or licensee.

As noted in detail above, it is highly preferred that the tire information database be continuously updated 14 using searching software operating to the task of data mining for information concerning tires and safety issues related thereto. Such would employ non-transitory computer readable medium operating an executable computer searching program, wherein the searching program includes computer executable code for first locating upon known websites, new websites, and existing network accessible government and industry sources, new information concerning tires identified as having safety issues.

Once new information has been so determined, computer executable code operating to the task of searching government and industry sources for the new information concerning newly discovered tires identified as having safety issues will take the step to add the tire identifiers relating to newly discovered tires found to have safety issues to the tire safety information database 12 along with any determined tire identifiers related thereto. Such may also be conducted by human personnel. However, to be continuous and ongoing, the computer search, as noted above is preferred.

Concurrently, the system operator will, on an ongoing basis, capture scanned tire identifiers and identification information 16 through the employment of digital imaging devices, either operated by the system provider or provided to system subscribers to capture tire identification information indicia 15 from tires 21 being sold for a vehicle 19 or from tires 21 already mounted on a vehicle 19 being serviced, or from tires 21 already mounted on a vehicle being sold.

As noted above, such an ongoing program to capture tire identification information and to generate scanned tire identifiers, using such imaging devices, may employ fixed imaging devices which can capture tire indicia 15 information, such as digital cameras on vehicle servicers driveways and alignment racks. Tire information, for the scanned tire identifiers from tire indicia 15, may also be captured with digital photography using drones 17 with onboard digital image capturing capability to capture one or multiple images of indicia 15 on tires 21, mounted on vehicles 19 located at a dealer or servicers venue, to yield the new tire identification information. The drones 17 can also be programmed to capture a digital image of the VIN number and/or license plate number (not shown but both well known to be positioned for easy imaging) of each vehicle 19 to be associated with each tire 21, so scanned and with the dealer or servicer.

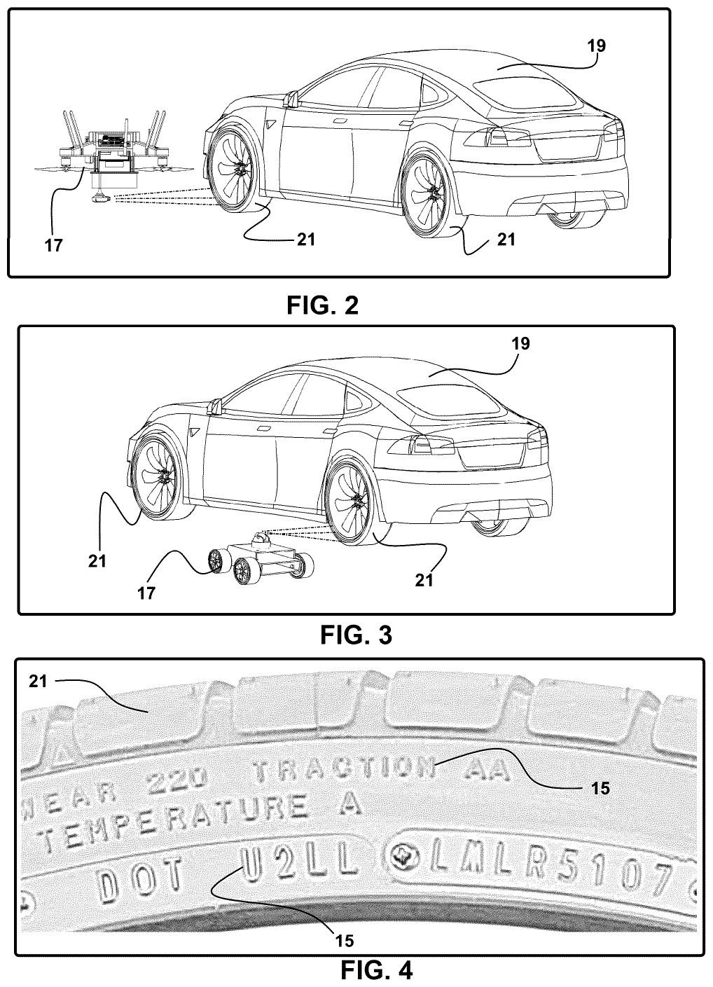

As shown in FIGS. 2-3 the drones 17 can be flying drones or wheeled drones 17, or both can be employed. A conventional onboard controller with software configured to operate the drone 17 to move appropriately to capture indicia 15 from each tire 21, and to capture the VIN number and or license plate number, before moving to the next vehicle 19, will operate the drones 17 autonomously.

Digital imaging, so captured, will be communicated to the system provider over the network. Each drone 17 may have conventional wired or wireless communications onboard and electronic memory onboard for storing digital imaging and later communicating the digital imaging of indicia 15 on the tires 21, and/or the VIN number or license plate number of the respective vehicle 19 having the identified tires 21, to the system provider.

On an ongoing basis, using the captured tire identification information from tire indicia 15 associated with the VIN number and/or license plate number identifying the respective vehicle 19 associated with identified tires 21, the system will form and add such information into a scanned tire identification database 18. Each tire added to this scanned tire identification database is assigned a scanned tire identifier which will be associated with the scanned tire mounted on a specific vehicle 19 by VIN number and or license plate number, which has been determined to have each respective tire 21 identified mounted thereon.

Using software operating to the task of comparing the scanned tire identifiers concerning tires 21 held in the scanned tire database, with the tire identifiers and tire information in the tire information database of tires with safety issues, matches therebetween are determined 20. It is preferred that this matching step be ongoing since the tire information database is preferably continuously updated, and tires in the scanned tire database, which may not have been matched in a past comparison, may be matched in a future comparison.

Where a match is determined between a scanned tire identifier and a tire identifier in the ongoing comparison 20, the system employing software configured to the task of email, SMS text, fax, or mail communication 22 will notify parties of interest, such as the vehicle owner, the vehicle manufacturer, the tire manufacturer, the vehicle dealer or service provider, and the owner of the vehicle.

The system may ascertain the owner of the vehicle with a respective VIN number and/or license plate number, identified as having tires 21 with determined safety issues, and begin notifications thereto, by employing software operating to search owners from conventionally available DMV records. The system will concurrently request a notification of receipt therefrom. The dealers and vehicle servicers, identified as related to the VIN number and/or license plate of the vehicle 19 identified as having tires 21 with safety issues, will also be notified with a communication, so they can also attempt contact with the vehicle owner.

Where a response is received from one or both of the vehicle owner and/or the vehicle seller or manufacturer or servicers, the system will note such and store a copy of that response and cease communications which elicited that response. Where no responses are received within a defined time period, such as a week or a month, the system will again communicate warnings 24. This ongoing communication of warnings will continue until a notification of receipt is received and stored in the system memory.

The system 10 herein, will, thus, identify tires 21 with safety issues and continuously attempt to match the tire identifiers of such tires identified with safety issues to the scanned tire identifiers of scanned tires 21 on vehicles 19 with VIN numbers and/or license plates identifying the vehicle 19 and the owners. By messaging manufacturers, owners, vehicle dealers and vehicle servicers found to be associated with an identified vehicle 19 having tires 21 having safety issues, the system will help to reduce tire failures, caused by defective or other dangerous tires, which often results in catastrophic injury or death.

While all of the fundamental characteristics and features of the tire identification and notification system described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. Other uses and/or features will include an app based non-commercial feature for use by a vehicle owner when shopping for tires, or when private parties such as potential buyers/sellers negotiate the price of a vehicle and/or tires.

It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A system for tire identification and notification of defects therewith, comprising:
one or more computer processors having memory communicably coupled thereto;
a computer program product tangibly embodied in a non-transitory machine-readable storage medium, including instructions that, when executed by said one or more computer processors, cause the one or more processors to perform the steps of:
compiling a tire safety information database with tire identifiers assigned to tires having safety issues;
capturing digital images of individual tire sidewalls of tires mounted upon individual vehicles visiting vehicle dealers or vehicle service providers;
assigning a vehicle identifier to each said individual vehicle based on a VIN number or license plate of said individual vehicle;
associating each said vehicle identifier to a said dealer or a said vehicle service provider for each said vehicle;
from said digital images of individual tire sidewalls, discerning a scanned tire identifier from alphanumeric characters within said digital images;
associating each said scanned tire identifier with a said vehicle identifier;
comparing each said scanned tire identifier with said tire identifiers assigned to tires having safety issues for a match; and
upon discerning a said match, communicating a warning to said dealer or service provider associated with said vehicle identifier having said match of said scanned tire identifier with said tire identifiers assigned to tires having safety issues.

2. The system for tire identification and notification of defects therewith of claim 1, additionally comprising the steps of:
continuously searching government, industry and private sources of tire safety information for newly identified tires having safety issues; and
assigning a new said tire identifier to each of said newly identified tires having said safety issues; and
adding each said new tire identifier as a said tire identifier to said tire safety information database.

3. The system for tire identification and notification of defects therewith of claim 1, additionally comprising the step of:
upon said discerning of a said match, communicating a warning to any of a servicer of said vehicle, a manufacturer of said vehicle or an owner of said vehicle.

4. The system for tire identification and notification of defects therewith of claim 2, additionally comprising the step of:
upon said discerning of a said match, communicating a warning to any of a servicer of said vehicle, a manufacturer of said vehicle or an owner of said vehicle.

5. The system for tire identification and notification of defects therewith of claim 3, additionally comprising the step of:
communicating said warning to said owner of said vehicle in the form of one or both of an electronic message communicated to said vehicle of said owner which is depicted on a graphic display in said vehicle or audibly announced in said vehicle.

6. The system for tire identification and notification of defects therewith of claim 4, additionally comprising the step of:
communicating said warning to said owner of said vehicle in the form of one or both of an electronic message communicated to said vehicle of said owner which is depicted on a graphic display in said vehicle or audibly announced in said vehicle.

7. The system for tire identification and notification of defects therewith of claim 1, additionally comprising the steps of:
employing a drone having a digital imager thereon for capturing said digital images of said individual tire sidewalls of tires mounted upon said individual vehicles visiting said vehicle dealers or said vehicle service providers; and
discerning said VIN number or said license plate number of said individual vehicle from a digital image thereof taken by said drone.

8. The system for tire identification and notification of defects therewith of claim 2, additionally comprising:
employing a drone having a digital imager thereon for capturing said digital images of said individual tire sidewalls of tires mounted upon said individual vehicles visiting said vehicle dealers or said vehicle service providers; and
discerning said VIN number or said license plate number of said individual vehicle from a digital image thereof taken by said drone.

9. The system for tire identification and notification of defects therewith of claim 3, additionally comprising:
employing a drone having a digital imager thereon for capturing said digital images of said individual tire sidewalls of tires mounted upon said individual vehicles visiting said vehicle dealers or said vehicle service providers; and
discerning said VIN number or said license plate number of said individual vehicle from a digital image thereof taken by said drone.

10. The system for tire identification and notification of defects therewith of claim 4, additionally comprising:
employing a drone having a digital imager thereon for capturing said digital images of said individual tire sidewalls of tires mounted upon said individual vehicles visiting said vehicle dealers or said vehicle service providers; and
discerning said VIN number or said license plate number of said individual vehicle from a digital image thereof taken by said drone.

11. The system for tire identification and notification of defects therewith of claim 5, additionally comprising:
employing a drone having a digital imager thereon for capturing said digital images of said individual tire sidewalls of tires mounted upon said individual vehicles visiting said vehicle dealers or said vehicle service providers; and
discerning said VIN number or said license plate number of said individual vehicle from a digital image thereof taken by said drone.

12. The system for tire identification and notification of defects therewith of claim 6, additionally comprising:
employing a drone having a digital imager thereon for capturing said digital images of said individual tire sidewalls of tires mounted upon said individual vehicles visiting said vehicle dealers or said vehicle service providers; and
discerning said VIN number or said license plate number of said individual vehicle from a digital image thereof taken by said drone.

13. The system for tire identification and notification of defects therewith of claim 7, additionally comprising:
employing a drone having a digital imager thereon for capturing said digital images of said individual tire sidewalls of tires mounted upon said individual vehicles visiting said vehicle dealers or said vehicle service providers; and
discerning said VIN number or said license plate number of said individual vehicle from a digital image thereof taken by said drone.

14. The system for tire identification and notification of defects therewith of claim 6, additionally comprising the step of:
continuously communicating said warning until a response is received acknowledging receipt of said warning.

15. A system for inspecting tires, comprising:
at least one digital camera to capture a digital image of a sidewall of a tire;
a computing device having one or more computer processors having memory communicably coupled thereto, said computing device having a connection to a computer network;
a computer-program product tangibly embodied in a non-transitory machine-readable storage medium running upon said computing device which includes instructions that, when executed by said one or more computer processors, cause the one or more processors to perform the steps of:
compiling a tire safety information database with tire identifiers assigned to tires having safety issues;
capturing digital images of individual tire sidewalls of tires mounted upon individual vehicles visiting vehicle dealers or vehicle service providers;
assigning a vehicle identifier to each said individual vehicle based on a VIN number or license plate of said individual vehicle;
associating each said vehicle identifier to a said dealer or a said vehicle service provider for each said vehicle;
from said digital images of individual tire sidewalls discerning a scanned tire identifier from alphanumeric characters within said digital images;
associating each said scanned tire identifier with a said vehicle identifier;
comparing each said scanned tire identifier with said tire identifiers assigned to tires having safety issues for a match; and
upon discerning a said match, communicating a warning to said dealer or service provider associated with said vehicle identifier having said match of said scanned tire identifier with said tire identifiers assigned to tires having safety issues.
